(19) United States
(12) Patent Application Publication
(10) Pub. No.: US 2026/0369469 A1
(43) Pub. Date: Nov. 19, 2026

(54) IGNITION COIL

(71) Applicant: DIAMOND&ZEBRA ELECTRIC MFG. CO., LTD., Osaka (JP)

(72) Inventors: Daiki YOSHIHARA, Osaka (JP); Takushi NISHIMURA, Osaka (JP)

(73) Assignee: DIAMOND&ZEBRA ELECTRIC MFG. CO., LTD., Osaka (JP)

(21) Appl. No.: 19/680,391

(22) Filed: May 18, 2026

(30) Foreign Application Priority Data
May 19, 2025 (JP) 2025-083037

(51) Int. Cl. H01F 38/12; H01F 27/24; H01F 27/32

(52) U.S. Cl. CPC H01F 38/12; H01F 27/24; H01F 27/325

(57) ABSTRACT

An ignition coil according to one embodiment includes a first coil set 30a and a second coil set 30b. The first coil set 30a includes a first primary bobbin 44a, and the second coil set 30b includes a second primary bobbin 44b having a shape corresponding to a shape of the first primary bobbin 44a rotated 180° about a central axis of the first primary bobbin 44a. A direction of a magnetic flux generated in the first primary bobbin 44a in response to a current flowing through a first primary coil 50a of the first coil set 30a is opposite to a direction of a magnetic flux generated in the second primary bobbin 44b in response to a current flowing through a second primary coil 50b of the second coil set 30b.

### CROSS-REFERENCE TO RELATED APPLICATION

This application claims priority to and the benefit of Patent Application No. 2025-83037 filed in JAPAN on May 19, 2025. The entire disclosure of this Japanese Patent Application is hereby incorporated by reference.

### BACKGROUND OF THE INVENTION

### FIELD OF THE INVENTION

The present specification relates to ignition coils.

### DESCRIPTION OF THE RELATED ART

In an internal combustion engine, an ignition coil is used to activate an ignition plug disposed in a combustion chamber. In general, such an ignition coil includes a set of an iron core, a primary coil, a secondary coil, and a bobbin (these components are collectively referred to herein as a “coil set”). In the ignition coil, a current flowing through the primary coil is blocked to generate a strong induced electromotive force in the secondary coil. The resulting high voltage is applied to the ignition plug to cause spark discharge, thereby igniting the fuel. The bobbin serves to insulate the iron core from the primary coil.

In recent years, internal combustion engines employing a lean fuel or a flame-retardant fuel such as ammonia have been implemented. These internal combustion engines require more energy for ignition and sustained combustion than conventional internal combustion engines. To meet this requirement, ignition coils including two coil sets have been investigated and put into practical use. For example, Japanese Laid-Open Patent Application Publication No. 2015-129464 discloses an ignition coil including two coil sets, which are alternately operated to lengthen the duration of discharge.

In a type of ignition coil including two coil sets, the iron cores of the coil sets share a common portion for downsizing. In this ignition coil, magnetic fluxes generated by the two coil sets both pass through the common portion. One possible approach to preventing magnetic flux saturation without increasing the cross-sectional area of the common portion is to arrange the coil sets such that the direction of the magnetic flux in the iron core of one of the coil sets is opposite to the direction of the magnetic flux in the iron core of the other coil set. In such a configuration, it is necessary to prepare two types of bobbins each of which is used in a corresponding one of the coil sets, and the use of the different bobbins imposes the additional burden of identifying the type of each bobbin and may cause assembly mistakes. This leads to an increase in manufacturing cost.

The present inventors aim to provide an ignition coil that includes two coil sets and that can be assembled with a minimal increase in manufacturing cost.

### SUMMARY OF THE INVENTION

An ignition coil according to one embodiment includes: a first coil set including a tubular first primary bobbin, a first primary coil wound around the first primary bobbin, a first secondary coil wound outside the first primary coil, and a first iron core extending through the first primary bobbin; and a second coil set including a tubular second primary bobbin, a second primary coil wound around the second primary bobbin, a second secondary coil wound outside the second primary coil, and a second iron core extending through the second primary bobbin. The second primary bobbin has a shape corresponding to a shape of the first primary bobbin rotated 180° about a central axis of the first primary bobbin. A direction of a magnetic flux generated in the first primary bobbin in response to a current flowing through the first primary coil is opposite to a direction of a magnetic flux generated in the second primary bobbin in response to a current flowing through the second primary coil.

In the ignition coil of the present embodiment, the direction of the magnetic flux generated in the first primary bobbin in response to a current flowing through the first primary coil is opposite to the direction of the magnetic flux generated in the second primary bobbin in response to a current flowing through the second primary coil, and the second primary bobbin has a shape corresponding to a shape of the first primary bobbin rotated 180° about its central axis. The first primary bobbin and the second primary bobbin may be of the same type. This embodiment realizes an ignition coil that includes two coil sets and that can be assembled with a minimal increase in manufacturing cost.

### BRIEF DESCRIPTION OF THE DRAWINGS

FIG. 1 is a perspective view showing an ignition coil according to one embodiment.

FIG. 2 is a cross-sectional view taken along the line II-II of FIG. 1.

FIG. 3 is an exploded perspective view of the ignition coil of FIG. 1.

FIG. 4 is an enlarged plan view showing the coil assembly of FIG. 3.

FIG. 5 is a cross-sectional view taken along the line V-V of FIG. 4.

FIG. 6A is a perspective view showing primary bobbins of the coil assembly of FIG. 4, and FIG. 6B is a front view of the primary bobbins of FIG. 6A.

FIG. 7 is a perspective view showing the coil assembly of FIG. 4 with secondary bobbins and secondary coils removed.

FIG. 8 is a plan view showing iron cores of the coil assembly of FIG. 4.

FIG. 9 is a circuit diagram of the ignition coil of FIG. 1.

### DETAILED DESCRIPTION

The following will describe preferred embodiments in detail with appropriate reference to the drawings.

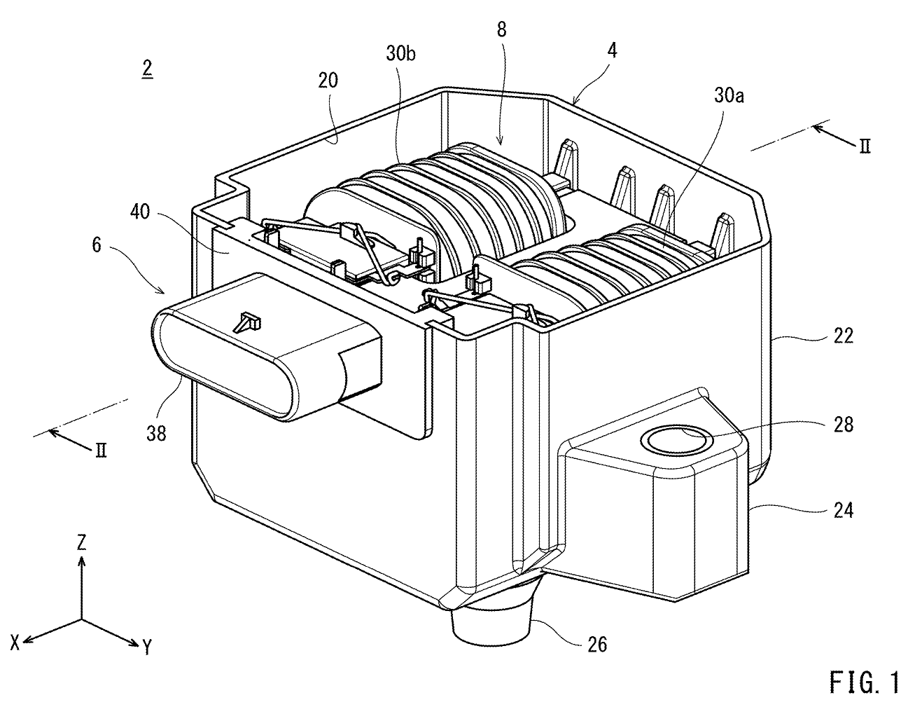

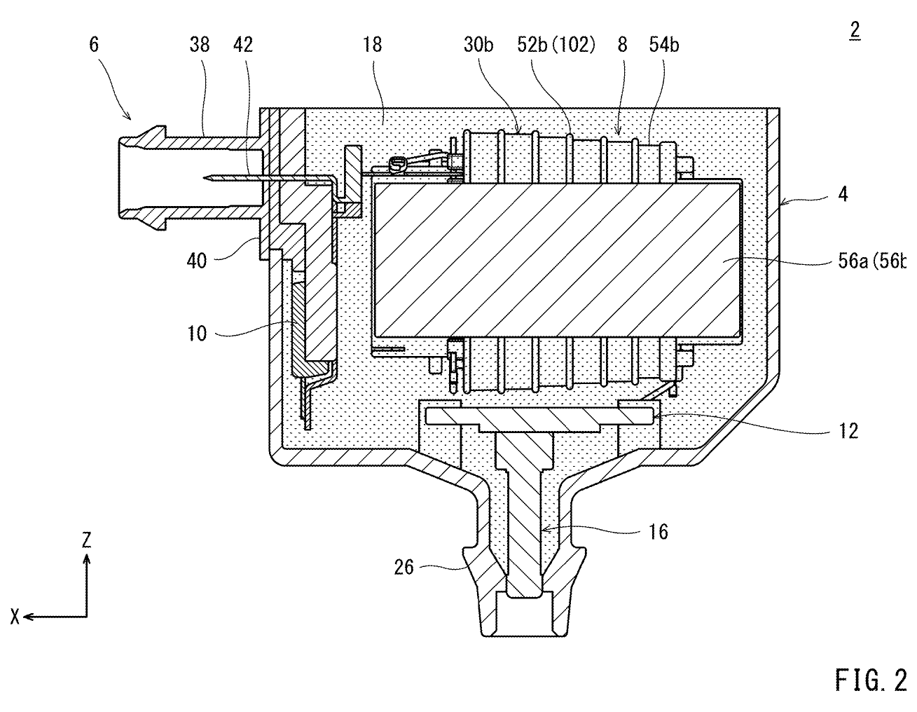

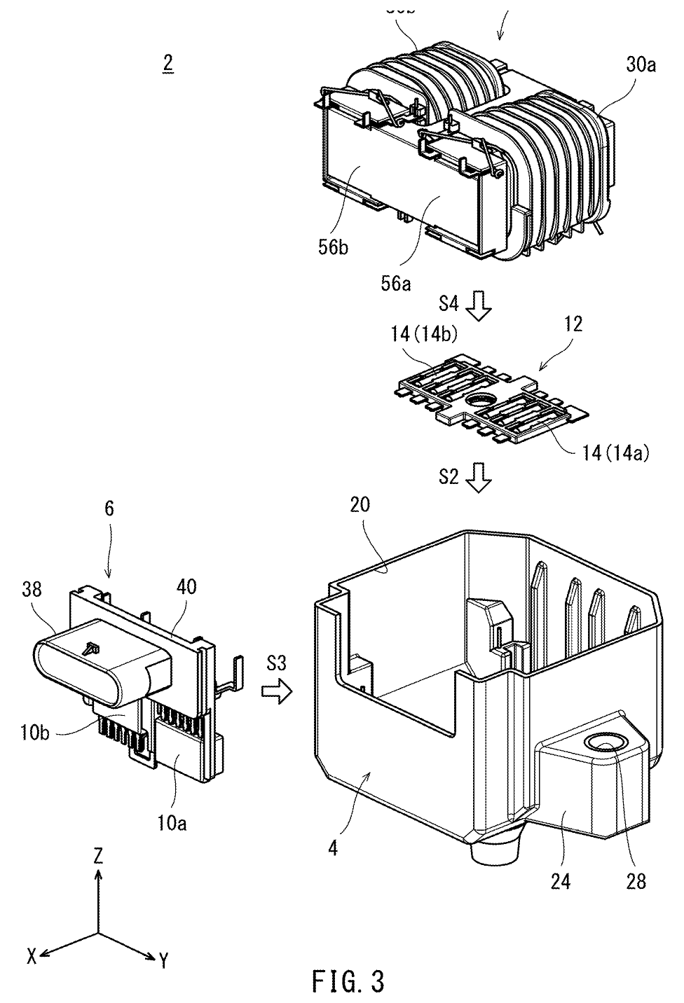

FIG. 1 is a perspective view showing an ignition coil 2 according to one embodiment. FIG. 2 is a cross-sectional view taken along the line II-II of FIG. 1. FIG. 3 is an exploded view of the ignition coil 2 of FIG. 1. In FIGS. 1 through 3, the arrow X represents the forward direction with respect to the ignition coil 2. The opposite direction is the backward direction. The arrow Y represents the rightward direction with respect to the ignition coil 2. The opposite direction is the leftward direction. The arrow Z represents the upward direction with respect to the ignition coil 2. The opposite direction is the downward direction. In this embodiment, the ignition coil 2 is intended for use in an engine that uses a flame-retardant fuel such as ammonia. As shown in FIG. 1, the ignition coil 2 includes a case 4, a connector portion 6, and a coil assembly 8. As shown in FIGS. 2 and 3, the ignition coil 2 further includes igniters 10, a diode support 12, diodes 14, a resistor 16, and a filler 18. In FIGS. 1 and 3, the filler 18 is omitted.

As shown in FIG. 3, the case 4 has a box shape. In this embodiment, the case 4 includes an opening 20 extending over the entire top surface and a part of the front surface (the surface on which the connector portion 6 is located). The case 4 is made of a resin composition. Preferred examples of materials for the case 4 include PBT (polybutylene terephthalate), PPS (polyphenylene sulfide), and PET (polyethylene terephthalate).

As shown in FIGS. 2 and 3, the case 4 includes a main body 22, a flange portion 24 extending rightward from the right side surface of the main body 22, and an output tower 26 extending downward from the bottom surface of the main body 22. Although not shown in FIG. 3, the case 4 further includes a flange portion extending leftward from the left side surface of the main body 22. The flange portion 24 includes a hole extending from the top to the bottom of the flange portion 24. Although not shown, a bolt is inserted into this hole and another hole in an engine to secure the ignition coil 2 to the engine. As shown in FIG. 2, the output tower 26 is tubular. In this embodiment, the main body 22, the flange portion 24, and the output tower 26 are formed integrally. The output tower 26 may be formed separately from the main body 22 and attached to the main body 22.

As shown in FIGS. 1 and 2, the coil assembly 8 is enclosed within the case 4. In FIG. 2, for ease of understanding, portions of the coil assembly 8 that are covered by the filler 18 are also shown with hatching representing the filler 18. In this embodiment, as shown in FIGS. 1 and 3, the coil assembly 8 includes a first coil set 30a and a second coil set 30b. The coil assembly 8 is a dual coil.

The connector portion 6 is located at the front of the case 4. The connector portion 6 receives a signal input from an external source. The connector portion 6 includes a tubular portion 38, a base portion 40, and a connector terminal 42. The tubular portion 38 has a tubular shape with a front opening. The connector terminal 42 is located within the tubular portion 38. There are a plurality of connector terminals 42. In this embodiment, the connector terminals 42 include a first control terminal for the first coil set 30a, a second control terminal for the second coil set 30b, a power supply terminal, and a ground terminal. The base portion 40 has a plate shape. In this embodiment, the base portion 40 covers that portion of the opening 20 of the case 4 which is located on the front surface of the case 4.

As shown in FIG. 2, the igniters 10 are enclosed within the case 4. In this embodiment, as shown in FIG. 3, there are a first igniter 10a for the first coil set 30a and a second igniter 10b for the second coil set 30b. Each igniter 10 is mounted on an igniter mounting portion included in the base portion 40. The first igniter 10a receives a control signal input from an external source through the first control terminal, and the second igniter 10b receives a control signal input from an external source through the second control terminal. As described later, in response to the control signal, each igniter 10 switches between permitting and blocking current flow through the primary coil of the corresponding coil set.

In this embodiment, as shown in FIG. 2, the resistor 16 is located within the output tower 26. In this embodiment, the lower end of the resistor 16 serves as an outlet for output signals from the ignition coil 2. In other words, in this embodiment, the lower end of the resistor 16 functions as an output terminal of the ignition coil 2. When the ignition coil 2 is mounted to an internal combustion engine, the output terminal is electrically connected to an ignition plug.

In another embodiment, the output terminal is not necessarily the lower end of the resistor 16. For example, in an embodiment in which the ignition coil 2 includes a spring extending downward from the lower end of the resistor 16, the lower end of the spring serves as the output terminal. In any case, the resistor 16 is electrically connected to the output terminal.

As shown in FIG. 2, the diode support 12 is located between the bottom surface of the case 4 and the coil assembly 8. The diode support 12 is mounted on the bottom surface of the case 4. The diode support 12 has the shape of a flat plate.

As shown in FIG. 3, the diodes 14 are mounted on the diode support 12. In this embodiment, six diodes 14 are secured to the diode support 12. Among these diodes 14, the three diodes 14 on the right side are connected in series via a pattern in the diode support 12. These three diodes 14 are collectively referred to as a “first diode set 14a”. Although not shown, a terminal for outputs from the first coil set 30a is connected to the first diode set 14a. The other three diodes 14 on the left side are connected in series via the pattern in the diode support 12. These three diodes 14 are collectively referred to as a “second diode set 14b”. Although not shown, a terminal for outputs from the second coil set 30b is connected to the second diode set 14b.

The filler 18 fills gaps present inside the case 4. The filler 18 is formed by hardening a fluid filling material. In this embodiment, the filler 18 is made of a thermosetting resin. The filler 18 insulates the secondary coils, which generate high voltages, from the other components. For this reason, a thermosetting resin with high insulation performance is selected as the material of the filler 18. To thoroughly fill the gaps present inside the case 4, a thermosetting resin that has low viscosity before hardening is selected as the material of the filler 18. Preferred examples of the filler 18 are epoxy resins.

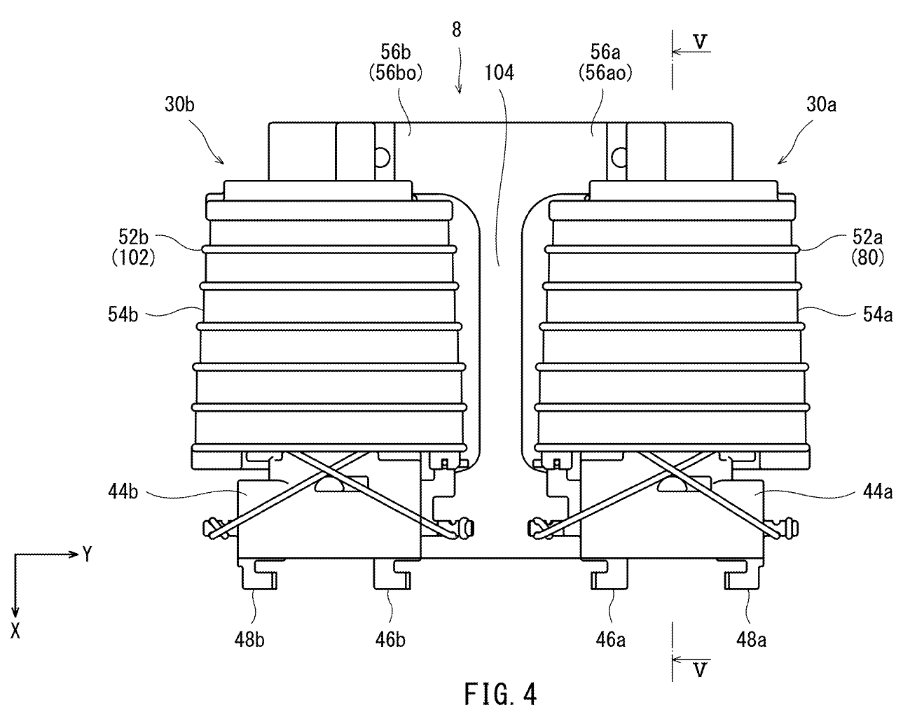

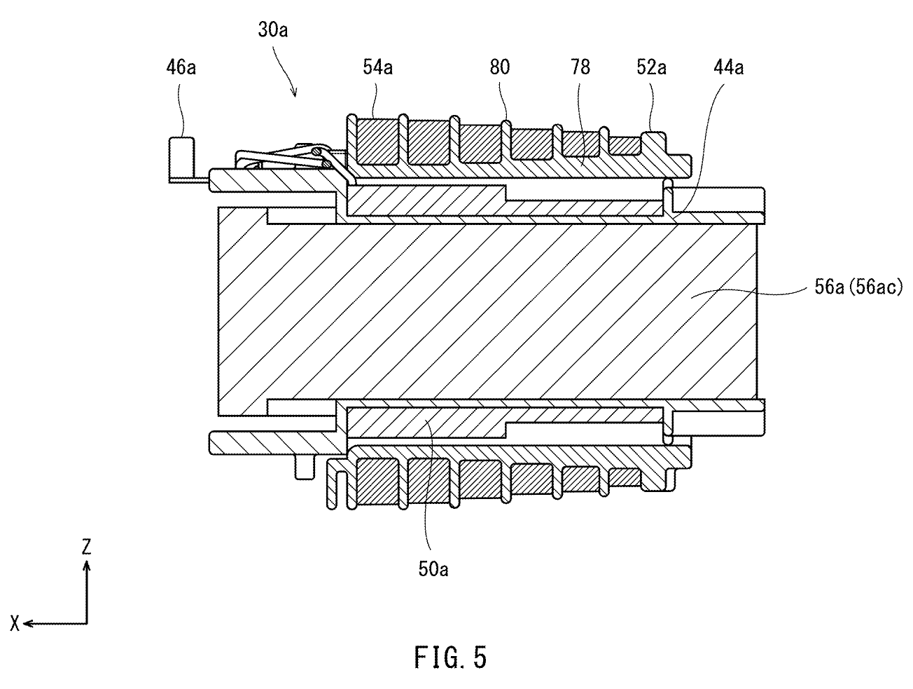

FIG. 4 is a plan view of the coil assembly 8 shown in FIG. 3. FIG. 5 is a cross-sectional view taken along the line V-V of FIG. 4. In this embodiment, as shown in FIGS. 4 and 5, the first coil set 30a includes a first primary bobbin 44a, a first positive terminal 46a, a first negative terminal 48a, a first primary coil 50a, a first secondary bobbin 52a, a first secondary coil 54a, and a first iron core 56a.

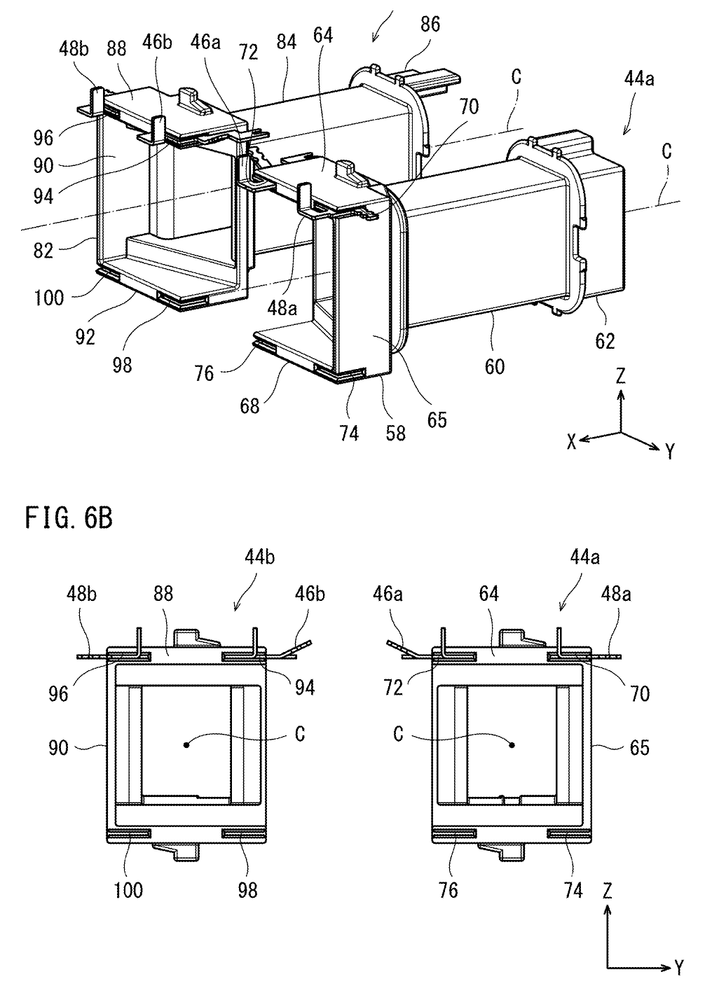

FIG. 6A is a perspective view showing the first primary bobbin 44a, and FIG. 6B is a front view of the first primary bobbin 44a. In these figures, a second primary bobbin 44b described later, as well as positive and negative terminals mounted on this bobbin, are also shown. The first primary bobbin 44a and the second primary bobbin 44b are arranged in parallel.

In this embodiment, the first primary bobbin 44a is generally tubular. The first primary bobbin 44a extends in the forward/backward direction. As shown in FIG. 6A, the first primary bobbin 44a includes a front portion 58, a middle portion 60, and a rear portion 62. The front portion 58 includes a ceiling 64, a right wall 65, and a bottom 68. The left, front, and rear surfaces of the front portion 58 are open. The middle portion 60 has a tubular shape having a somewhat smaller diameter than the front portion 58. The left, front, and rear surfaces of the rear portion 62 are open. As shown in FIGS. 6A and 6B, the front portion 58 includes an upper right slit 70 extending from the front surface to the right side surface of the ceiling 64, an upper left slit 72 extending from the front surface to the left side surface of the ceiling 64, a lower right slit 74 extending from the front surface to the right side surface of the bottom 68, and a lower left slit 76 extending from the front surface to the left side surface of the bottom 68. The first primary bobbin 44a is made of a resin.

The first positive terminal 46a and the first negative terminal 48a are mounted on the first primary bobbin 44a. A portion of the first positive terminal 46a is fitted in the upper left slit 72. A portion of the first negative terminal 48a is fitted in the upper right slit 70. The first positive terminal 46a serves as a current inlet of the first primary coil 50a, and the first negative terminal 48a serves as a current outlet of the first primary coil 50a. The first positive terminal 46a and the first negative terminal 48a are electrically conductive. The first positive terminal 46a and the first negative terminal 48a are typically made of a metal.

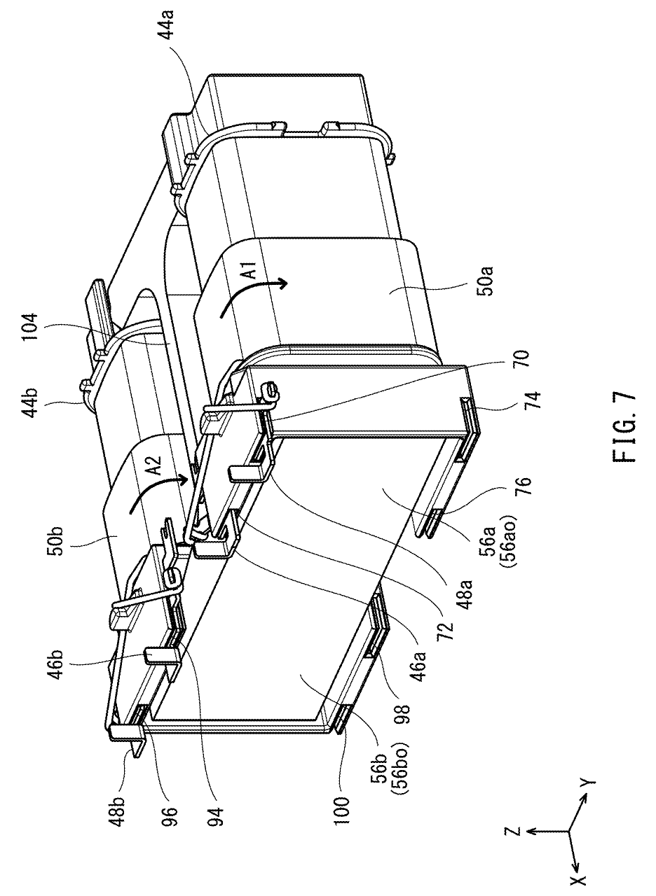

The first primary coil 50a is formed by winding a wire around the outer periphery of the middle portion 60 of the first primary bobbin 44a. FIG. 7 shows the coil assembly 8 with the secondary coils and the secondary bobbins removed. FIG. 7 shows the first primary bobbin 44a on which the wire of the first primary coil 50a is wound. In this embodiment, the wire begins to be wound from the first positive terminal 46a in the direction A1 of FIG. 7, and finishes being wound at the first negative terminal 48a. The first positive terminal 46a is a coil-winding start end from which the winding of the first primary coil 50a starts, and the first negative terminal 48a is a coil-winding finish end at which the winding of the first primary coil 50a finishes. A typical example of the material of the wire is copper (Cu).

The first secondary bobbin 52a is tubular. The first secondary bobbin 52a extends in the forward/backward direction. The first secondary bobbin 52a is located outside the first primary coil 50a. As shown in FIG. 5, the first secondary bobbin 52a includes a body portion 78 and a plurality of flanges 80 projecting outward from the body portion 78. In FIG. 4, only the outer ends of the flanges 80 are shown. The first secondary bobbin 52a is made of a resin.

The first secondary coil 54a is formed by winding a wire around the outer periphery of the first secondary bobbin 52a. The wire is wound around the outer periphery of the body portion 78 between each pair of adjacent flanges 80. The number of turns of the wire of the first secondary coil 54a is much greater than the number of turns of the wire of the first primary coil 50a. A typical example of the material of the wire of the first secondary coil 54a is copper.

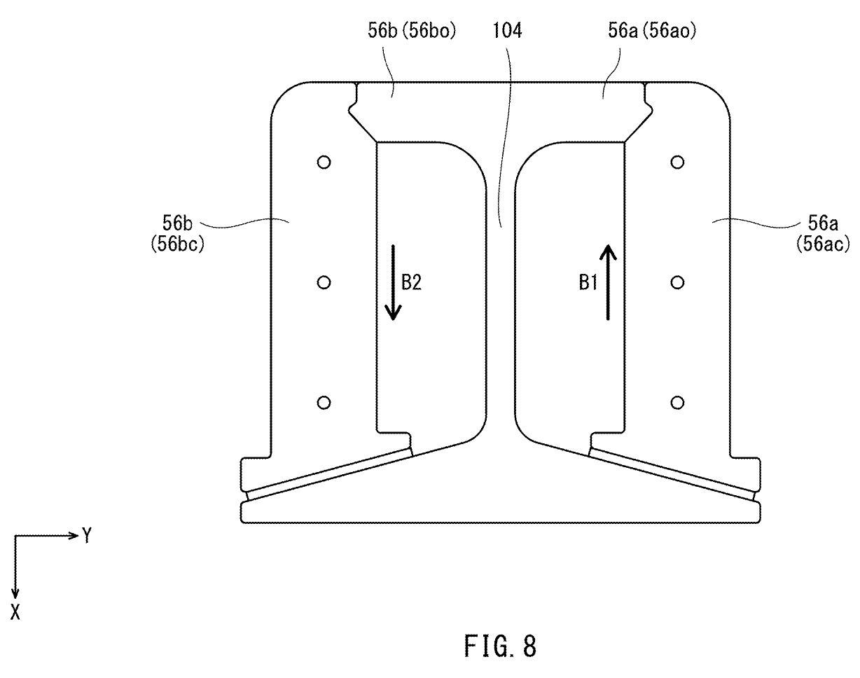

FIG. 8 is a plan view showing the first iron core 56a. In this figure, a second iron core 56b described later is also shown. The first iron core 56a is generally ring-shaped. The first iron core 56a includes a first central iron core 56ac and a first outer iron core 56ao. As shown in FIG. 5, the first central iron core 56ac extends through the center of the first primary bobbin 44a. The first outer iron core 56ao extends from one end of the first central iron core 56ac, passes outside the first secondary coil 54a (see FIG. 4), and reaches the other end of the first central iron core 56ac. The first central iron core 56ac and the first outer iron core 56ao form an iron core loop. Typically, the first central iron core 56ac and the first outer iron core 56ao are made of a magnetic material. Preferred examples of magnetic materials include ferrite, magnetic dust, and silicon steel.

In this embodiment, as shown in FIGS. 4, 6 and 7, the second coil set 30b includes a second primary bobbin 44b, a second positive terminal 46b, a second negative terminal 48b, a second primary coil 50b, a second secondary bobbin 52b, a second secondary coil 54b, and a second iron core 56b.

In this embodiment, as shown in FIG. 6A, the second primary bobbin 44b is generally tubular. The second primary bobbin 44b extends in the forward/backward direction. The second primary bobbin 44b includes a front portion 82, a middle portion 84, and a rear portion 86. The front portion 82 includes a ceiling 88, a left wall 90, and a bottom 92. The right, front, and rear surfaces of the front portion 82 are open. The middle portion 84 has a tubular shape having a somewhat smaller diameter than the front portion 82. The right, front, and rear surfaces of the rear portion 86 are open. As shown in FIGS. 6A and 6B, the front portion 82 includes an upper right slit 94 extending from the front surface to the right side surface of the ceiling 88, an upper left slit 96 extending from the front surface to the left side surface of the ceiling 88, a lower right slit 98 extending from the front surface to the right side surface of the bottom 92, and a lower left slit 100 extending from the front surface to the left side surface of the bottom 92. The second primary bobbin 44b is made of a resin.

In FIGS. 6A and 6B, the reference signs C represent the respective central axes of the primary bobbins. In this embodiment, the second primary bobbin 44b has a shape corresponding to a shape of the first primary bobbin 44a rotated 180° about its central axis. The upper right slit 70 of the first primary bobbin 44a corresponds to the lower left slit 100 of the second primary bobbin 44b. The upper left slit 72 of the first primary bobbin 44a corresponds to the lower right slit 98 of the second primary bobbin 44b. That is, the first primary bobbin 44a and the second primary bobbin 44b are primary bobbins having the same shape but positioned at different rotation angles.

The second positive terminal 46b and the second negative terminal 48b are mounted on the second primary bobbin 44b. A portion of the second positive terminal 46b is fitted in the upper right slit 94. A portion of the second negative terminal 48b is fitted in the upper left slit 96. The second positive terminal 46b serves as a current inlet of the second primary coil 50b, and the second negative terminal 48b serves as a current outlet of the second primary coil 50b. The second positive terminal 46b and the second negative terminal 48b are electrically conductive. The second positive terminal 46b and the second negative terminal 48b are typically made of a metal.

In this embodiment, in a front view, the order in which the first positive terminal 46a and the first negative terminal 48a are arranged in the leftward/rightward direction is opposite to the order in which the second positive terminal 46b and the second negative terminal 48b are arranged in the leftward/rightward direction. This relationship is shown in FIG. 6B. In this embodiment, the first positive and negative terminals 46a and 48a and the second positive and negative terminals 46b and 48b are substantially symmetrical with respect to a plane perpendicular to the leftward/rightward direction.

As shown in FIG. 7, the second primary coil 50b is formed by winding a wire around the outer periphery of the middle portion 84 of the second primary bobbin 44b. In this embodiment, the wire begins to be wound from the second negative terminal 48b in the direction A2 of FIG. 7, and finishes being wound at the second positive terminal 46b. The second negative terminal 48b is a coil-winding start end from which the winding of the second primary coil 50b starts, and the second positive terminal 46b is a coil-winding finish end at which the winding of the second primary coil 50b finishes. A typical example of the material of the wire is copper.

As shown in FIG. 7, the direction A1 in which the wire of the first primary coil 50a is wound and the direction A2 in which the wire of the second primary coil 50b is wound are the same. However, in the first primary coil 50a, the winding of the wire starts from the positive terminal (inlet-side terminal) and finishes at the negative terminal (outlet-side terminal), whereas in the second primary coil 50b, the winding of the wire starts from the negative terminal and finishes at the positive terminal. Accordingly, the direction of a current flowing through the first primary coil 50a (counterclockwise or clockwise direction about the central axis of the coil in a front view) and the direction of a current flowing through the second primary coil 50b are opposite to each other.

In the example described above, “the first positive terminal 46a is a coil-winding start end and the first negative terminal 48a is a coil-winding finish end,” and “the second negative terminal 48b is a coil-winding start end and the second positive terminal 46b is a coil-winding finish end.” In another embodiment, this relationship may be reversed. That is, the configuration may be such that “the first positive terminal 46a is a coil-winding finish end and the first negative terminal 48a is a coil-winding start end,” and “the second negative terminal 48b is a coil-winding finish end, and the second positive terminal 46b is a coil-winding start end.” It is sufficient that for one of the first and second primary coils 50a and 50b, the positive terminal is a coil-winding start end and the negative terminal is a coil-winding finish end, and for the other of the first and second primary coils 50a and 50b, the negative terminal is a coil-winding start end and the positive terminal is a coil-winding finish end.

The second secondary bobbin 52b is tubular. The second secondary bobbin 52b extends in the forward/backward direction. The second secondary bobbin 52b is located outside the second primary coil 50b. The second secondary bobbin 52b includes a body portion and a plurality of flanges 102 projecting outward from the body portion. In FIG. 4, only the outer ends of the flanges 102 are shown. The second secondary bobbin 52b is made of a resin.

The second secondary coil 54b is formed by winding a wire around the outer periphery of the second secondary bobbin 52b. The wire is wound around the outer periphery of the body portion between each pair of adjacent flanges 102. The number of turns of the wire of the second secondary coil 54b is much greater than the number of turns of the wire of the second primary coil 50b. A typical example of the material of the wire of the second secondary coil 54b is copper.

As shown in FIG. 8, the second iron core 56b is generally ring-shaped. The second iron core 56b includes a second central iron core 56bc and a second outer iron core 56bo. The second central iron core 56bc extends through the center of the second primary bobbin 44b. The second outer iron core 56bo extends from one end of the second central iron core 56bc, passes outside the second secondary coil 54b (see FIG. 4), and reaches the other end of the second central iron core 56bc. The second central iron core 56bc and the second outer iron core 56bo form an iron core loop. Typically, the second central iron core 56bc and the second outer iron core 56bo are made of a magnetic material. Preferred examples of magnetic materials include ferrite, magnetic dust, and silicon steel.

As shown in FIG. 8, the first outer iron core 56ao and the second outer iron core 56bo share a common portion 104. The first outer iron core 56ao and the second outer iron core 56bo are integrated with each other. The width of the common portion 104 is smaller than the widths of the other portions of the first and second iron cores 56a and 56b. The cross-sectional area of the common portion 104 is smaller than the cross-sectional areas of the other portions of the first and second iron cores 56a and 56b. As shown in FIG. 4, the common portion 104 is located between the first secondary coil 54a and the second secondary coil 54b.

In FIG. 8, the arrow B1 indicates the direction of a magnetic flux generated in the first primary bobbin 44a in response to a current flowing through the first primary coil 50a. This direction is the magnetic flux direction in the first iron core 56a. The arrow B2 indicates the direction of a magnetic flux generated in the second primary bobbin 44b in response to a current flowing through the second primary coil 50b. This direction is the magnetic flux direction in the second iron core 56b. As described above, the directions of the currents flowing through the first primary coil 50a and the second primary coil 50b are opposite. Accordingly, the directions B1 and B2 are opposite, and the magnetic fluxes are oriented in opposite directions in the common portion 104. When currents flow through both the first primary coil 50a and the second primary coil 50b simultaneously, the magnetic flux derived from the first primary coil 50a and the magnetic flux derived from the second primary coil 50b cancel each other in the common portion 104. As a result, magnetic flux saturation in the common portion 104 is prevented despite its small cross-sectional area.

In this embodiment, the ignition coil 2 is produced through the following steps of:

(S1) preparing the coil assembly 8;

(S2) mounting the diode support 12 to the case 4;

(S3) mounting the connector portion 6 to the case 4;

(S4) placing the coil assembly 8 into the case 4; and

(S5) forming the filler 18 in the case 4.

In step S1, the coil assembly 8 shown in FIG. 4 is assembled. In this step, the first primary bobbin 44a and the second primary bobbin 44b are prepared. As described above, these bobbins are of the same type, and one of the bobbins corresponds to the other bobbin rotated 180°. The first positive terminal 46a and the first negative terminal 48a are mounted to the first primary bobbin 44a. The second positive terminal 46b and the second negative terminal 48b are mounted to the second primary bobbin 44b. In this manner, the terminal-equipped primary bobbins shown in FIG. 6 are formed.

Furthermore, in step S1, a wire is wound around the first primary bobbin 44a to form the first primary coil 50a. The wire begins to be wound from the first positive terminal 46a, and finishes being wound at the first negative terminal 48a. A wire is wound around the second primary bobbin 44b to form the second primary coil 50b. The wire begins to be wound from the second negative terminal 48b, and finishes being wound at the second positive terminal 46b. As described above, the wire winding direction is the same for the formation of the first primary coil 50a and the formation of the second primary coil 50b.

Furthermore, in step S1, the first secondary bobbin 52a is placed on the outside of the first primary coil 50a, and a wire is then wound around the first secondary bobbin 52a to form the first secondary coil 54a. Similarly, the second secondary bobbin 52b is placed on the outside of the second primary coil 50b, and a wire is then wound around the second secondary bobbin 52b to form the second secondary coil 54b. Subsequently, the first iron core 56a and the second iron core 56b are mounted. This completes assembly of the coil assembly 8.

The first central iron core 56ac of the first iron core 56a may be mounted before the formation of the first primary coil 50a or the first secondary coil 54a. The second central iron core 56bc of the second iron core 56b may be mounted before the formation of the second primary coil 50b or the second secondary coil 54b. In this case, the first and second outer iron cores 56ao and 56bo, which are integrated together, are mounted at a final stage of assembly. The first secondary bobbin 52a may be placed on the outside of the first primary coil 50a after a wire is wound around the first secondary bobbin 52a. The second secondary bobbin 52b may be placed on the outside of the second primary coil 50b after a wire is wound around the second secondary bobbin 52b.

In step S2, the resistor 16 is mounted to the case 4. The resistor 16 is inserted into a hole of the output tower 26 of the case 4. Furthermore, as shown in FIG. 3, the diode support 12 is placed into the case 4 through the opening 20 of the case 4 and mounted to the inner surface of the bottom of the case 4.

In step S3, as shown in FIG. 3, the connector portion 6 is mounted to the case 4. The igniters 10 are mounted to the connector portion 6 beforehand. The connector portion 6 is mounted to the case 4 such that the igniters 10 are located within the case 4 and the base portion 40 of the connector portion 6 covers the front portion of the opening 20 of the case 4.

In step S4, as shown in FIG. 3, the coil assembly 8 is placed into the case 4 through the opening 20 of the case 4. The coil assembly 8 is supported by an unillustrated support portion of the case 4. Thus, as shown in FIG. 2, a predetermined distance is maintained between the coil assembly 8 and the diode support 12.

In step S5, a fluid filler material is poured into the case 4. The fluid filler material fills gaps present inside the case 4. The filler material is then hardened. In this embodiment, the hardening of the filler material is accomplished by heating. As a result, the filler material becomes the filler 18. This completes assembly of the ignition coil 2.

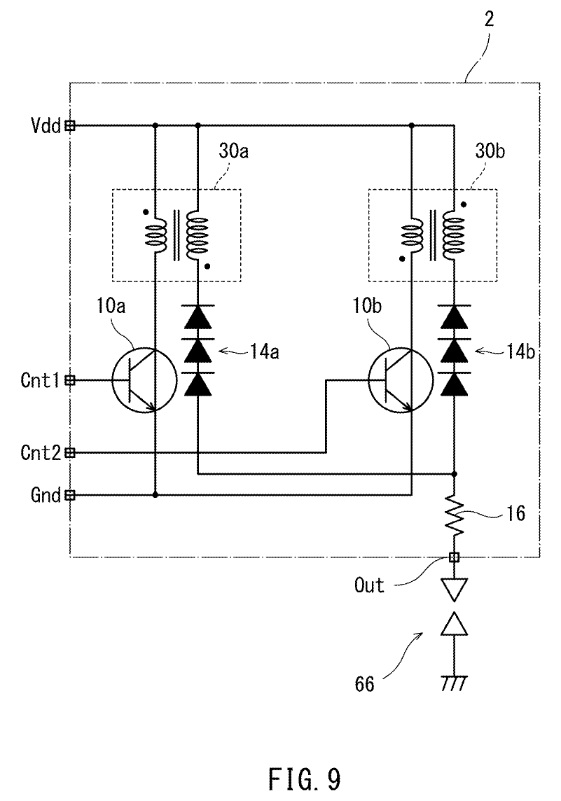

FIG. 9 shows a circuit diagram of the ignition coil 2 of FIG. 1. This figure further includes a circuit diagram of an ignition plug 66. The circuit diagram includes the first coil set 30a, the first igniter 10a, the first diode set 14a, the second coil set 30b, the second igniter 10b, and the second diode set 14b as components of the ignition coil 2. The circuit diagram further includes a first control terminal Cnt1, a second control terminal Cnt2, an output terminal Out, a power supply terminal Vdd, and a ground terminal Gnd as external terminals of the ignition coil 2. In this embodiment, as described above, the first control terminal Cnt1, the second control terminal Cnt2, the power supply terminal Vdd, and the ground terminal Gnd are the connector terminals 42. As described above, the lower end of the resistor 16 serves as the output terminal Out.

The first control terminal Cnt1 is connected to the first igniter 10a. In response to a signal from the first control terminal Cnt1, the first igniter 10a switches between permitting (ON) and blocking (OFF) current flow through the first primary coil 50a. When current flow through the first primary coil 50a switches from ON to OFF, a high voltage is generated in the first secondary coil 54a. The terminal for outputs from the first secondary coil 54a is connected to the first diode set 14a, and the first diode set 14a is connected to the resistor 16. The first diode set 14a is forward-biased with respect to the high voltage applied from the first coil set 30a. Thus, the high voltage passes through the first diode set 14a into the resistor 16. The high voltage from the first coil set 30a is output from the output terminal Out and input to the ignition plug 66.

The second control terminal Cnt2 is connected to the second igniter 10b. In response to a signal from the second control terminal Cnt2, the second igniter 10b switches between ON and OFF of current flow through the second primary coil 50b. When current flow through the second primary coil 50b switches from ON to OFF, a high voltage is generated in the second secondary coil 54b. The terminal for outputs from the second secondary coil 54b is connected to the second diode set 14b, and the second diode set 14b is connected to the resistor 16. The second diode set 14b is forward-biased with respect to the high voltage applied from the second coil set 30b. Thus, the high voltage passes through the second diode set 14b into the resistor 16. The high voltage from the second coil set 30b is output from the output terminal Out and input to the ignition plug 66.

As shown in FIG. 9, the output of the first coil set 30a and the output of the second coil set 30b are short-circuited between the first and second diode sets 14a and 14b and the resistor 16. When a high voltage is output from the first coil set 30a in the absence of high voltage output from the second coil set 30b, the second diode set 14b is reverse-biased with respect to the high voltage applied from the first coil set 30a. The second diode set 14b prevents the output current from the first coil set 30a from flowing into the second coil set 30b. Likewise, when a high voltage is output from the second coil set 30b in the absence of high voltage output from the first coil set 30a, the first diode set 14a is reverse-biased with respect to the high voltage applied from the second coil set 30b. The first diode set 14a prevents the output current from the second coil set 30b from flowing into the first coil set 30a.

The following describes the workings and effects of the present embodiment.

In the present embodiment, the second primary bobbin 44b has a shape corresponding to a shape of the first primary bobbin 44a rotated 180° about its central axis. The first primary bobbin 44a and the second primary bobbin 44b may be of the same type. This embodiment eliminates the additional burden of distinguishing between the first primary bobbin 44a and the second primary bobbin 44b during assembly and reduces the risk of assembly mistakes.

In the present embodiment, the direction of a magnetic flux generated in the first primary bobbin 44a in response to a current flowing through the first primary coil 50a is opposite to the direction of a magnetic flux generated in the second primary bobbin 44b in response to a current flowing through the second primary coil 50b. Accordingly, when there is the common portion 104 shared by the first iron core 56a and the second iron core 56b, the magnetic flux generated by the current flowing through the first primary coil 50a and the magnetic flux generated by the current flowing through the second primary coil 50b can be oriented in opposite directions in the common portion 104. As a result, magnetic flux saturation in the common portion 104 can be prevented even when the common portion 104 has a small cross-sectional area. This embodiment allows for downsizing of the ignition coil 2.

In the present embodiment, winding of the first primary coil 50a starts from the first positive terminal 46a and finishes at the first negative terminal 48a, whereas winding of the second primary coil 50b starts from the second negative terminal 48b and finishes at the second positive terminal 46b. In such a configuration, where the relationship as to which of the positive and negative terminals (which of the current inlet and the current outlet) coil winding starts from and finishes at is reversed between the first primary coil 50a and the second primary coil 50b, it is easy to ensure that the direction of a magnetic flux generated in the first primary bobbin 44a in response to a current flowing through the first primary coil 50a is opposite to the direction of a magnetic flux generated in the second primary bobbin 44b in response to a current flowing through the second primary coil 50b.

In the present embodiment, in a front view, the order in which the first positive terminal 46a and the first negative terminal 48a are arranged in the leftward/rightward direction is opposite to the order in which the second positive terminal 46b and the second negative terminal 48b are arranged in the leftward/rightward direction. Accordingly, the direction of primary coil winding can be the same when the first primary coil 50a begins to be wound from the first positive terminal 46a and finishes being wound at the first negative terminal 48a and when the second primary coil 50b begins to be wound from the second negative terminal 48b and finishes being wound at the second positive terminal 46b. This facilitates assembly of the ignition coil 2 and contributes to reducing the risk of assembly mistakes.

In the present embodiment, as shown in FIG. 6, the two positive terminals are located around the center in the leftward/rightward direction, and the two negative terminals are located near both ends in the leftward/rightward direction. Alternatively, the two negative terminals may be located around the center in the leftward/rightward direction, and the two positive terminals may be located near both ends in the leftward/rightward direction.

In the present embodiment, the first outer iron core 56ao and the second outer iron core 56bo share the common portion 104 located between the first secondary coil 54a and the second secondary coil 54b. Since the common portion 104, whose cross-sectional area can be reduced, is located between the first secondary coil 54a and the second secondary coil 54b, the distance between the first secondary coil 54a and the second secondary coil 54b can also be reduced. This embodiment allows for downsizing of the ignition coil 2.

As described above, the present embodiment can provide an ignition coil that includes two coil sets and that can be assembled with a minimal increase in manufacturing cost. This demonstrates the superiority of the present embodiment.

### Disclosed Items

The following items disclose preferred embodiments.

### Item 1

An ignition coil including:
a first coil set including a tubular first primary bobbin, a first primary coil wound around the first primary bobbin, a first secondary coil wound outside the first primary coil, and a first iron core extending through the first primary bobbin; and
a second coil set including a tubular second primary bobbin, a second primary coil wound around the second primary bobbin, a second secondary coil wound outside the second primary coil, and a second iron core extending through the second primary bobbin, wherein
the second primary bobbin has a shape corresponding to a shape of the first primary bobbin rotated 180° about a central axis of the first primary bobbin, and
a direction of a magnetic flux generated in the first primary bobbin in response to a current flowing through the first primary coil is opposite to a direction of a magnetic flux generated in the second primary bobbin in response to a current flowing through the second primary coil.

### Item 2

The ignition coil according to item 1, wherein

the first coil set further includes a positive terminal as a current inlet of the first primary coil, and a negative terminal as a current outlet of the first primary coil,

the second coil set further includes a positive terminal as a current inlet of the second primary coil, and a negative terminal as a current outlet of the second primary coil,

for one of the first and second primary coils, the positive terminal is a coil-winding start end from which winding of the one of the first and second primary coils starts, and the negative terminal is a coil-winding finish end at which the winding of the one of the first and second primary coils finishes, and

for the other of the first and second primary coils, the negative terminal is a coil-winding start end from which winding of the other of the first and second primary coils starts, and the positive terminal is a coil-winding finish end at which the winding of the other of the first and second primary coils finishes.

### Item 3

The ignition coil according to item 2, wherein in a front view, an order in which the positive terminal and the negative terminal of the first primary coil are arranged in a leftward/rightward direction is opposite to an order in which the positive terminal and the negative terminal of the second primary coil are arranged in the leftward/rightward direction.

### Item 4

The ignition coil according to any one of items 1 to 3, wherein in a front view, a direction in which the first primary coil is wound around the first primary bobbin is the same as a direction in which the second primary coil is wound around the second primary bobbin.

### Item 5

The ignition coil according to any one of items 1 to 4, wherein

the first iron core includes a first central iron core extending through the first primary coil, and a first outer iron core located outside the first secondary coil,

the second iron core includes a second central iron core extending through the second primary coil, and a second outer iron core located outside the second secondary coil, and

the first outer iron core and the second outer iron core share a common portion located between the first secondary coil and the second secondary coil.

The foregoing description is given for illustrative purposes, and various modifications can be made without departing from the principles of the present invention.

What is claimed is:

1. An ignition coil comprising:
a first coil set including a tubular first primary bobbin, a first primary coil wound around the first primary bobbin, a first secondary coil wound outside the first primary coil, and a first iron core extending through the first primary bobbin; and
a second coil set including a tubular second primary bobbin, a second primary coil wound around the second primary bobbin, a second secondary coil wound outside the second primary coil, and a second iron core extending through the second primary bobbin, wherein
the second primary bobbin has a shape corresponding to a shape of the first primary bobbin rotated 180° about a central axis of the first primary bobbin, and
a direction of a magnetic flux generated in the first primary bobbin in response to a current flowing through the first primary coil is opposite to a direction of a magnetic flux generated in the second primary bobbin in response to a current flowing through the second primary coil.

2. The ignition coil according to claim 1, wherein
the first coil set further includes a positive terminal as a current inlet of the first primary coil, and a negative terminal as a current outlet of the first primary coil,
the second coil set further includes a positive terminal as a current inlet of the second primary coil, and a negative terminal as a current outlet of the second primary coil,
for one of the first and second primary coils, the positive terminal is a coil-winding start end from which winding of the one of the first and second primary coils starts, and the negative terminal is a coil-winding finish end at which the winding of the one of the first and second primary coils finishes, and
for the other of the first and second primary coils, the negative terminal is a coil-winding start end from which winding of the other of the first and second primary coils starts, and the positive terminal is a coil-winding finish end at which the winding of the other of the first and second primary coils finishes.

3. The ignition coil according to claim 2, wherein in a front view, an order in which the positive terminal and the negative terminal of the first primary coil are arranged in a leftward/rightward direction is opposite to an order in which the positive terminal and the negative terminal of the second primary coil are arranged in the leftward/rightward direction.

4. The ignition coil according to claim 1, wherein in a front view, a direction in which the first primary coil is wound around the first primary bobbin is the same as a direction in which the second primary coil is wound around the second primary bobbin.

5. The ignition coil according to claim 1, wherein
the first iron core includes a first central iron core extending through the first primary coil, and a first outer iron core located outside the first secondary coil,
the second iron core includes a second central iron core extending through the second primary coil, and a second outer iron core located outside the second secondary coil, and
the first outer iron core and the second outer iron core share a common portion located between the first secondary coil and the second secondary coil.
